(19) United States
(12) Patent Application Publication
(10) Pub. No.: US 2009/0119361 A1
(43) Pub. Date: May 7, 2009

(54) CACHE MANAGEMENT FOR PARALLEL ASYNCHRONOUS REQUESTS IN A CONTENT DELIVERY SYSTEM

(75) Inventors: Erik J. Burckart, Raleigh, NC (US); Andrew J. Ivory, Wake Forest, NC (US); Todd E. Kaplinger, Raleigh, NC (US); Stephen J. Kenna, Morrisville, NC (US); Aaron K. Shook, Morrisville, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/934,162

(22) Filed: Nov. 2, 2007

(51) Int. Cl. G06F 15/16

(52) U.S. Cl. 709/203

(57) ABSTRACT

Embodiments of the present invention provide a method, system and computer program product for cache management in handling parallel asynchronous requests for content in a content distribution system. In an embodiment of the invention, a method for cache management method for handling parallel asynchronous requests for content in a content distribution system can include servicing multiple parallel asynchronous requests from different requesting clients for a page before all fragments in the page have been retrieved by returning previously cached ones of the fragments to the requesting clients and returning remaining ones of the fragments in the page to the requesting clients as retrieved from non-cached storage. The method further can include assembling the page once all fragments in the page have been retrieved from non-cached storage. Finally, the method can include caching the assembled page to subsequently service requests for the page.

### BACKGROUND OF THE INVENTION

1. Field of the Invention

The present invention relates to the field of content delivery in a content delivery system and more particularly to page caching requested content in an asynchronous request-response content delivery system.

2. Description of the Related Art

A content delivery system is a computing system in which content can be centrally stored and delivered on demand to communicatively coupled requesting clients disposed about a computer communications network. Generally, content is delivered in a content delivery system on a request-response basis. Specifically, a request-response computing system refers to a computing system configured to receive requests from requesting clients, to process those requests and to provide some sort of response to the requesting clients over a computer communications network. Traditionally Web based requests have been synchronous in nature primarily because in the hypertext transfer protocol (HTTP), the server cannot push responses back to the client. Rather, the HTTP client initiates a request that creates a connection to the server, the server processes the request, and the server sends back the response on the same connection.

Asynchronous forms of content delivery, however, can be desirable in that a connection need not be maintained between client and server in the asynchronous model. To support asynchronous content delivery, generally clients continuously poll the server once a content request has been issued in order to determine when a response is ready. Still, in a Web based request response computing system, once a request is received in a processing server, the processing server cannot respond to the requester until a response is ready. Thus, returning a response as quickly as possible can reduce the number of connections required in support of polling in an asynchronous content delivery pattern.

Caching as a technology has long provided relief for content delivery systems in terms of responsiveness. When utilizing a cache, a requested page once retrieved can be stored in readily accessible memory for subsequent retrieval when requested again by a different requestor. When applied to the asynchronous model, fewer connections are required to poll the content server for a response to a request when requested content has been previously pushed to the cache. Even, still not all content is a simple page and with the dynamic assembly of different fragments in a page, the problem has changed.

Specifically, with the surge of asynchronous request technologies, the paradigm has changed and previous techniques for caching need to be re-examined. In this regard, a page cannot be cached until all of the respective fragments in a page also have been retrieved. Of course, the processing of fragments is driven by the client content browser which identifies the need for the fragment in the page and issues a request for the fragment only after the page referencing the fragment has been delivered to the client. Only then can the entire page be composed and placed in a cache. Retrieving the different fragments for a page, however, can be time consuming and ca involve multiple request response exchanges between client and server. In the interim, through, requesting clients cannot enjoy the benefit of a cached copy of the page.

### BRIEF SUMMARY OF THE INVENTION

Embodiments of the present invention address deficiencies of the art in respect to serving content requests in a content delivery system and provide a novel and non-obvious method, system and computer program product for cache management in handling parallel asynchronous requests for content in a content distribution system. In an embodiment of the invention, a method for cache management method for handling parallel asynchronous requests for content in a content distribution system can include servicing multiple parallel asychronous requests from different requesting clients for a page before all fragments in the page have been retrieved by returning previously cached ones of the fragments to the requesting clients and returning remaining ones of the fragments in the page to the requesting clients as retrieved from non-cached storage. The method further can include assembling the page once all fragments in the page have been retrieved from non-cached storage. Finally, the method can include caching the assembled page to subsequently service requests for the page.

In one aspect of the embodiment, servicing multiple parallel requests from different requesting clients for a page before all fragments in the page have been retrieved can include receiving a first page request for a page from a first requestor, the page comprising embedded fragments and retrieving the page and the embedded fragments from non-cache storage, returning the page and the embedded fragments to the first requester, and pushing the page and the embedded fragments to a cache. Additionally, in the aspect of the embodiment, the method further can include additionally receiving a parallel second page request from a second requester subsequent to the first page request but before all embedded fragments have been pushed to the cache, and retrieving the page and cached ones of the embedded fragments from the cache, further retrieving remaining ones of the embedded fragments from non-cache storage, returning the page and the embedded fragments to the second requestor.

In yet another aspect of the embodiment, the method can include yet additionally receiving a parallel third page request from a third requester subsequent to the first page request and the second page request but before all embedded fragments have been pushed to the cache. Thereafter, the page and cached ones of the embedded fragments can be retrieved from the cache. Concurrently, the remaining ones of the embedded fragments can be retrieved from non-cache storage and the page and the embedded fragments can be returned to the third requestor.

In another embodiment of the invention, a content delivery data processing system can be configured for handling parallel asynchronous requests for content, for example HTTP requests. The system can include non-cached storage storing multiple different pages each referencing fragments. The system also can include cached storage caching retrieved ones of the pages and fragments, and a content server coupled to both the cached storage and non-cached storage. The content server can be configured to serve a requested one of the pages and fragments referenced from the requested one of the pages from cached storage when available and otherwise from the non-cached storage. Finally, the system can include cache management logic.

The logic can include program code enabled to service multiple parallel requests from different requesting clients for a requested one of the page before all fragments referenced by the page have been retrieved by returning previously cached ones of the fragments in the cached storage to the requesting clients and returning remaining ones of the fragments in the page to the requesting clients as retrieved from the non-cached storage, to assemble the page once all fragments in the page have been retrieved from non-cached storage, and to push the assembled page to cached storage to subsequently service requests for the page

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an event diagram illustrating a cache management process for handling parallel asynchronous requests in a content delivery system;

FIG. 2 is a schematic illustration of a content delivery data processing system configured for cache management of parallel asynchronous request; and,

FIG. 3 is a flow chart illustrating a cache management process for handling parallel asynchronous requests.

### DETAILED DESCRIPTION OF THE INVENTION

Embodiments of the present invention provide a method, system and computer program product for cache management to handle parallel asynchronous requests in a content delivery system. In accordance with an embodiment of the present invention, asynchronous content requests for a page can be fielded from different clients in parallel. In response to each request for a page, the page content and embedded fragments can be retrieved where not available in a common cache. The page can be returned to the requesting clients and requests for embedded fragments can be issued by the requesting clients as identified in the page. As fragments are retrieved, the fragments can be pushed to the cache.

Notably, subsequent ones of the parallel requests can retrieve the cached fragments directly from the cache whether or not all of the fragments in the page have been cached. Once all fragments in a page have been cached and returned to the requesting clients, the page can be composed in the cache. In this way, subsequent requesters can receive a cached copy of the page with fragments. Yet, requests received in the midst of retrieving the fragments for the page can be handled to the extent possible with those fragments already present in the common cache.

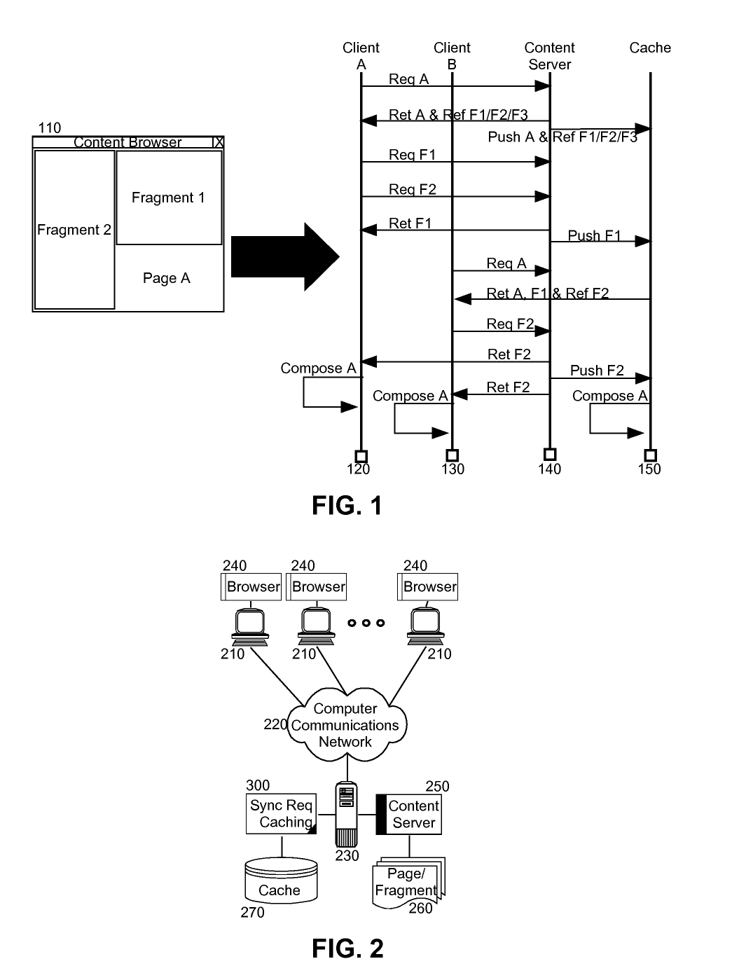

In illustration, FIG. 1 is an event diagram illustrating a cache management process for handling parallel asynchronous requests in a content delivery system. As shown in FIG. 1, a first client 120 can request from a content server 140 a page from within content browser 110. The page can include a set of fragments (two fragments shown for the sake of illustrative simplicity). Additionally, the content server 140 can push the returned page into the cache 150. In response to the request, the content server 140 can return the requested page including embedded references to the fragments. Upon receiving the returned page, the first client 120 can request each of the fragments separately.

The content server 140 can work in earnest to retrieve the requested fragments and as the first fragment is received, the content server 140 both can push the first fragment onto the cache 150 and also the content server 140 can return the first fragment to the first client 120. Before the content server 140 is able to retrieve the second fragment, however, a second client 130 can request the page from the content server 140. In as much as the page and the first fragment already have been pushed to the cache 150, however, the content server 140 can return a copy of the page and the first fragment to the second client 130 which in turn can identify the embedded reference to the second fragment and can issue a request for the same.

Thereafter, the content server 140 can retrieve the second fragment and the content server 140 can both push the second fragment to the cache 150 and also the content server 140 can return the second fragment to the first client 120 and the second client 130. Finally, the entirety of the page can be composed with the fragments in each of the first client 120, the second client 130 and in the cache 150. In this way, subsequent requesting clients can receive a complete copy of the page from the cache 150 on request. Yet, for those clients requesting in parallel a copy of the page before all fragments have been received, at least a portion of the page and the fragments can be returned from the cache 150 so as to accelerate the performance of content delivery.

The content delivery process shown in FIG. 1 can be performed within a content delivery data processing system. In illustration, FIG. 2 schematically depicts a content delivery data processing system configured for cache management of parallel asynchronous request. The system can include a host computing platform 230 communicatively coupled to multiple different clients 210 over a computer communications network 220. The host computing platform 230 can include a content server 250 configured to distribute pages and respectively referenced fragments 260 to each of the clients 210 for rendering in corresponding content browsers 240.

As illustrated, a cache 270 can be provided into which retrieved ones of the pages and respectively referenced fragments 260 can be cached for delivery to requesting ones of the clients 210. Notably, cache management logic 300 for parallel asynchronous requests can be coupled to the cache 270. The logic 300 can include program code enabled to service multiple parallel requests for a page with fragments with fragments stored in the cache 270 before the entire page has been assembled through the retrieval of all fragments referenced in the page. In particular, as each fragment in a requested page is retrieved, the program code of the logic 300 can be enabled to push the fragment to the cache 270 for delivery to other clients requesting the page in parallel even before the remaining fragments in the page are retrieved and the entire page can be assembled.

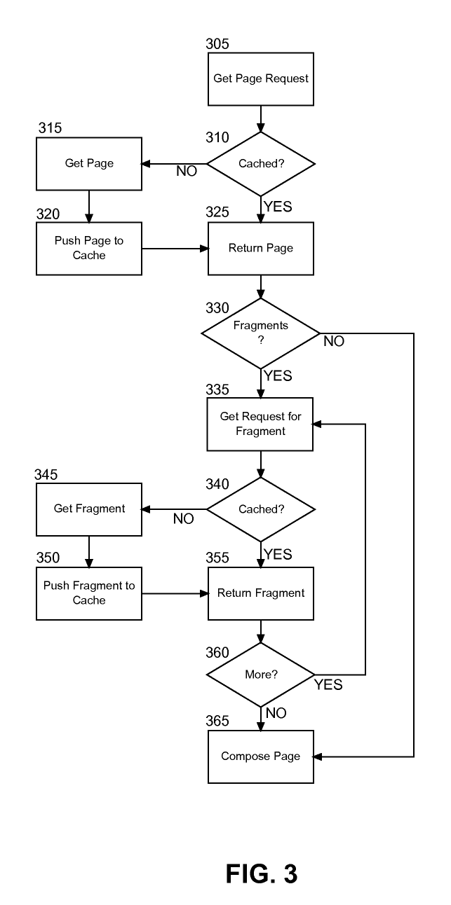

In yet further illustration, FIG. 3 is a flow chart illustrating a cache management process for handling parallel asynchronous requests. Beginning in block 305, an asynchronous page request can be received for a page. Subsequently, in decision block 310 it can be determined whether or not the requested page already has been cached from a previous request. If not, in block 315 the page can be retrieved and in block 320 the page can be pushed to the cache. Thereafter, in block 325 the page can be returned to the requesting client.

In decision block 330, it can be determined whether or not the requested page references one or more fragments. If so, in block 335 a request for one of the referenced fragments can be received from a requesting one of the clients. In decision block 340, it can be determined whether or not the requested fragment has been cached. If not, in block 345 the requested fragment can be retrieved and in block 350 the retrieved fragment can be pushed to the cache. Thereafter, in block 355 the fragment can be returned to the requesting ones of the clients. Finally, in decision block 360 it can be determined whether or not fragments referenced in the requested page remain to be retrieved. If not, the process can repeat through block 335. However, if so, in block 365 the page can be composed and the composed page can be cached for delivery to subsequent requesters.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A cache management method for handling parallel asynchronous requests for content in a content distribution system, the method comprising:
servicing multiple parallel asynchronous requests from different requesting clients for a page before all fragments in the page have been retrieved by returning previously cached ones of the fragments to the requesting clients and returning remaining ones of the fragments in the page to the requesting clients as retrieved from non-cached storage;
assembling the page once all fragments in the page have been retrieved from non-cached storage; and,
caching the assembled page to subsequently service requests for the page.

2. The method of claim 1, wherein servicing multiple parallel requests from different requesting clients for a page before all fragments in the page have been retrieved, comprises:
receiving a first page request for a page from a first requestor, the page comprising embedded fragments;
retrieving the page and the embedded fragments from non-cache storage, returning the page and the embedded fragments to the first requestor, and pushing the page and the embedded fragments to a cache;
additionally receiving a parallel second page request from a second requester subsequent to the first page request but before all embedded fragments have been pushed to the cache; and,
retrieving the page and cached ones of the embedded fragments from the cache, further retrieving remaining ones of the embedded fragments from non-cache storage, returning the page and the embedded fragments to the second requestor.

3. The method of claim 2, further comprising:
yet additionally receiving a parallel third page request from a third requester subsequent to the first page request and the second page request but before all embedded fragments have been pushed to the cache; and,
retrieving the page and cached ones of the embedded fragments from the cache, further retrieving remaining ones of the embedded fragments from non-cache storage, returning the page and the embedded fragments to the third requestor.

4. A content delivery data processing system configured for handling parallel asynchronous requests for content comprising:
non-cached storage storing a plurality of pages each referencing fragments;
cached storage caching retrieved ones of the pages and fragments;
a content server coupled to both the cached storage and non-cached storage, the content server being configured to serve a requested one of the pages and fragments referenced from the requested one of the pages from cached storage when available and otherwise from the non-cached storage; and,
cache management logic comprising program code enabled to service multiple parallel asynchronous requests from different requesting clients for a requested one of the page before all fragments referenced by the page have been retrieved by returning previously cached ones of the fragments in the cached storage to the requesting clients and returning remaining ones of the fragments in the page to the requesting clients as retrieved from the non-cached storage, to assemble the page once all fragments in the page have been retrieved from non-cached storage, and to push the assembled page to cached storage to subsequently service requests for the page

5. The system of claim 4, wherein the requests are hypertext transfer protocol (HTTP) requests for a Web page.

6. A computer program product comprising a computer usable medium embodying computer usable program code for cache management in handling parallel asynchronous requests for content in a content distribution system, the computer program product comprising:
computer usable program code for servicing multiple parallel asynchronous requests from different requesting clients for a page before all fragments in the page have been retrieved by returning previously cached ones of the fragments to the requesting clients and returning remaining ones of the fragments in the page to the requesting clients as retrieved from non-cached storage;
computer usable program code for assembling the page once all fragments in the page have been retrieved from non-cached storage; and,
computer usable program code for caching the assembled page to subsequently service requests for the page.

7. The computer program product of claim 6, wherein the computer usable program code for servicing multiple parallel requests from different requesting clients for a page before all fragments in the page have been retrieved, comprises:
computer usable program code for receiving a first page request for a page from a first requester, the page comprising embedded fragments;
computer usable program code for retrieving the page and the embedded fragments from non-cache storage, returning the page and the embedded fragments to the first requester, and pushing the page and the embedded fragments to a cache;
computer usable program code for additionally receiving a parallel second page request from a second requester subsequent to the first page request but before all embedded fragments have been pushed to the cache; and,
computer usable program code for retrieving the page and cached ones of the embedded fragments from the cache, further retrieving remaining ones of the embedded fragments from non-cache storage, returning the page and the embedded fragments to the second requestor.

8. The computer program product of claim 7, further comprising:
computer usable program code for yet additionally receiving a parallel third page request from a third requester subsequent to the first page request and the second page request but before all embedded fragments have been pushed to the cache; and,
computer usable program code for retrieving the page and cached ones of the embedded fragments from the cache, further retrieving remaining ones of the embedded fragments from non-cache storage, returning the page and the embedded fragments to the third requester.
